(19) United States
(12) Patent Application Publication
(10) Pub. No.: US 2025/0386863 A1
(43) Pub. Date: Dec. 25, 2025

(54) HEATER ASSEMBLY AND METHOD

(71) Applicant: NICOVENTURES TRADING LIMITED, London (GB)

(72) Inventor: Ugurhan YILMAZ, London (GB)

(21) Appl. No.: 19/101,939

(22) PCT Filed: Aug. 7, 2023
(86) PCT No.: PCT/GB2023/052080

§ 371 Date: Feb. 7, 2025

(30) Foreign Application Priority Data
Aug. 8, 2022 (GB) 2211518.2

(51) Int. Cl. A24F 40/46; A24F 40/485; A24F 40/70; H05B 3/22

(52) U.S. Cl. CPC A24F 40/46; A24F 40/485; A24F 40/70; H05B 3/22

(57) ABSTRACT

A heater assembly for an aerosol provision system, the heater assembly including: a substrate; a heater layer configured to generate heat when supplied with energy, the heater layer provided on a first surface of the substrate; one or more capillary tubes extending from another surface of the substrate through the heater layer provided on the first surface of the substrate; and an airflow channel extending from another surface of the substrate through the heater layer provided on the first surface of the substrate, the airflow channel configured to allow air to flow through the heater assembly. Also described is a cartomizer including the heater assembly, an aerosol provision system including the heater assembly, and a method for manufacturing the heater assembly.

### RELATED APPLICATIONS

The present application is a National Phase entry of PCT Application No. PCT/GB2023/052080 filed Aug. 7, 2023, which claims priority to GB Application No. 2211518.2 filed Aug. 8, 2022, each of which is hereby incorporated by reference in their entirety.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporization. An aerosol source for an aerosol provision system may thus comprise a heater having a heating element arranged to receive source liquid from the reservoir, for example through wicking/capillary action. While a user inhales on the device, electrical power is supplied to the heating element to vaporize source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Typically, such aerosol provision systems are provided with heater assemblies suitable for heating the source liquid to form an aerosol. However, conventional heater assemblies do not necessarily provide an efficient liquid supply to the heater element of the heater assembly in various circumstances.

Moreover, heater assemblies are typically provided in or adjacent an airflow (formed by the air drawn into the aerosol provision system by a user inhaling on the mouthpiece). The way in which the air interacts with the heater assembly can lead to differences observed in the aerosol subsequently generated.

Various approaches are described which seek to help address some of these issues.

### SUMMARY

According to a first aspect of certain embodiments there is provided a heater assembly for an aerosol provision system, the heater assembly including: a substrate; a heater layer configured to generate heat when supplied with energy, the heater layer provided on a first surface of the substrate; one or more capillary tubes extending from another surface of the substrate through the heater layer provided on the first surface of the substrate; and an airflow channel extending from another surface of the substrate through the heater layer provided on the first surface of the substrate, the airflow channel configured to allow air to flow through the heater assembly.

According to a second aspect of certain embodiments there is provided a cartomizer for use with an aerosol-generating device for generating aerosol from an aerosol-generating material, the cartomizer including: a reservoir for storing aerosol-generating material, and a heater assembly according to the first aspect, wherein the heater assembly is provided in fluid communication with the reservoir.

According to a third aspect of certain embodiments there is provided an aerosol provision system for generating aerosol from an aerosol-generating material, the aerosol provision system including the heater assembly of the first aspect.

According to a fourth aspect of certain embodiments there is provided a method of manufacturing a heater assembly for an aerosol provision system, the method including: providing a substrate comprising a heater layer configured to generate heat when supplied with energy, the heater layer provided on a first surface of the substrate; forming one or more capillary tubes extending from another surface of the substrate through the heater layer provided on the first surface of the substrate; and forming an airflow channel extending from another surface of the substrate through the heater layer provided on the first surface of the substrate, the airflow channel configured to allow air to flow through the heater assembly.

According to a fifth aspect of certain embodiments there is provided heater means for an aerosol provision system, the heater means including a substrate; heater layer means configured to generate heat when supplied with energy, the heater layer means provided on a first surface of the substrate; capillary means extending from another surface of the substrate through the heater layer means provided on the first surface of the substrate; and airflow means extending from another surface of the substrate through the heater layer means provided on the first surface of the substrate, the airflow means configured to allow air to flow through the heater means.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a perspective view of an aerosol provision system in accordance with aspects of the present disclosure;

FIG. 2 is an exploded perspective view of a cartomizer suitable for use in the aerosol provision system of FIG. 1;

FIG. 3 is a cross-sectional view of the cartomizer of FIG. 2 in an assembled state, in particular showing the arrangement of the heater assembly relative to the remaining components of the cartomizer;

FIG. 4 is a perspective view of a heater assembly in accordance with aspects of the present disclosure, wherein the heater assembly comprises a substrate, an electrically resistive layer, and an airflow channel extending through the substrate and electrically resistive layer;

FIGS. 5a and 5b are cross-sectional views of a section of the heater assembly of FIG. 4 showing different arrangements of the heater assembly comprising an airflow channel of FIG. 4; FIG. 5a shows a configuration of the heater assembly for use in systems where a more turbulent airflow is desired according to a first implementation, while FIG. 5b shows a configuration of the heater assembly for use in systems where a more laminar airflow is desired according to a second implementation; and

FIG. 6 is a method in accordance with aspects of the present disclosure for forming a heater assembly.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device, electronic cigarette or electronic nicotine delivery system (END), although it is noted that the presence of nicotine in the aerosol-generating material is not a requirement. Throughout the following description the term “e-cigarette” is sometimes used but this term may be used interchangeably with aerosol (vapor) provision system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product. In some embodiments, the or each aerosol-generating material may comprise one or more active constituents, one or more flavors, one or more aerosol-former materials, and/or one or more other functional materials.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a mouthpiece, and/or an aerosol-modifying agent.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

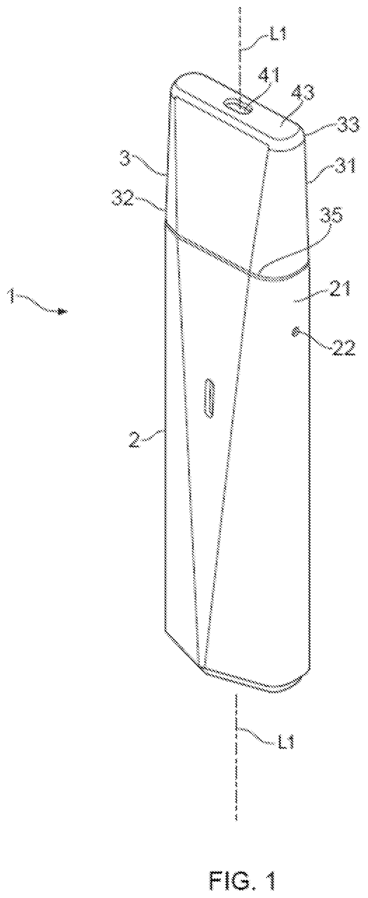

FIG. 1 shows an aerosol provision system 1 comprising an aerosol provision device 2 and a consumable 3, herein shown and referred to as a cartomizer 3. The cartomizer 3 is configured to engage and disengage with the aerosol provision device 2. That is, the cartomizer 3 is releasably connected/connectable to the aerosol provision device 2. More specifically, the cartomizer 3 is configured to engage/disengage with the aerosol provision device 2 along the longitudinal axis L1. The cartomizer 3 and aerosol provision device 2 are provided with suitable interfaces to allow the cartomizer 3 and aerosol provision device 2 to engage/disengage from one another, e.g., a push fit interface, a screwthread interface, etc. The specific way in which the cartomizer 3 engages with the aerosol provision device 2 is not significant for the principles of the present disclosure.

The cartomizer 3 comprises a reservoir which stores an aerosol-generating material. In the following, the aerosol-generating material is a liquid aerosol-generating material. The liquid aerosol-generating material (herein sometimes referred to as liquid) may be a conventional e-liquid which may or may not contain nicotine. However, other liquids and/or aerosol generating materials may be used in accordance with the principles of the present disclosure. The cartomizer 3 is able to be removed from the aerosol provision device 2 when, for example, the cartomizer 3 requires refilling with liquid or replacement with another (full) cartomizer 3.

The aerosol provision device 2 comprises a power source (such as a rechargeable battery) and control electronics. As will be described below, the cartomizer 3 comprises an electrically powered heater assembly. When the cartomizer 3 is coupled to the aerosol provision device 2, the control electronics is configured to supply electrical power to the heater assembly of the cartomizer 3 to cause the heater assembly to generate an aerosol from the liquid aerosol-generating material. The control electronics may be provided with various components to facilitate/control the supply of power to the cartomizer 3. For example, the control electronics may be provided with an airflow sensor configured to detect when a user of the aerosol provision system 1 inhales on the aerosol provision system and to supply power in response to such a detection and/or a push button which is pressed by the user and to supply power in response to such a detection. However, it should be understood that additional functions may be controlled by the control electronics depending on the configuration of the aerosol provision device 2 (for example, the control electronics may be configured to control/regulate recharging of the power source, or to facilitate wireless communication with another electronic device, such as a smartphone). The features and functions of the aerosol provision device 2 are not of primary significance in respect of the present disclosure.

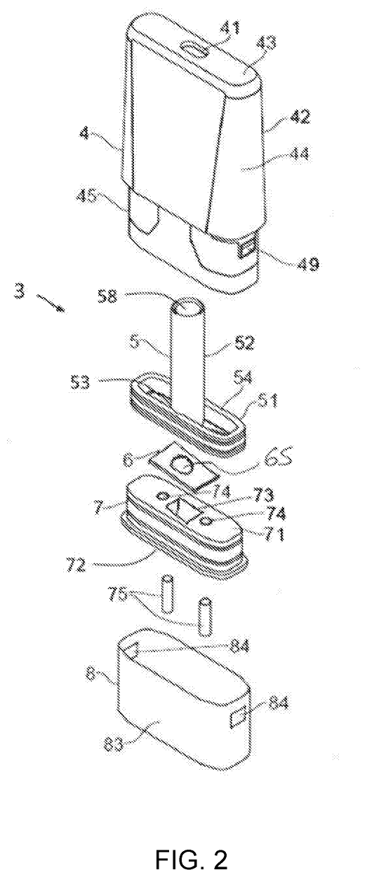

FIG. 2 shows an example cartomizer 3 suitable for use in the aerosol provision system of FIG. 1. From the exploded view of FIG. 2, it may be seen that the cartomizer 3 is assembled from a stack of components: an outer housing 4, an upper clamping unit 5, a heater assembly 6, a lower support unit 7 and an end cap 8.

The cartomizer 3 has a top end 31 and a bottom end 32 which are spaced apart along the longitudinal axis L1, which is the longitudinal axis of the cartomizer as well as being the longitudinal axis of the aerosol provision system 1. The top end 31 of the cartomizer defines a mouthpiece end of the aerosol provision system 1 (on which a user may place their mouth and inhale), and the mouthpiece 33 includes a mouthpiece orifice 41 which is provided at the top end 42 of outer housing 4 in the center of a top face 43.

The outer housing 4 includes a circumferential side wall 44 which leads down from the top end 42 to a bottom end 45 of the outer housing 4 and which defines an internal reservoir (not shown) for holding the liquid aerosol-generating material. Prior to assembly of the cartomizer 3, the bottom end 45 of the outer housing is open, but upon assembly the bottom end 45 is closed by a plug formed by the upper clamping unit 5 and the lower support unit 7 which are stacked together with the heater assembly 6 sandwiched therebetween.

The upper clamping unit 5 is an intermediate component of the stack of components. The upper clamping unit 5 includes a foot 51 in the form of a block and an upwardly extending air tube 52. On each side of the air tube 52, the foot 51 includes a well 53 which descends from a flat top surface 54 to a flat bottom surface (not shown in FIG. 2) of the foot 51. At the bottom surface, each well 53 is open and, specifically, opens into an elongate recess formed in the bottom surface, with the depth of the recess broadly matching the size/shape and thickness of the heater assembly 6. The foot 51 is designed to engage with the outer housing 4 (more specifically, such that the outer circumferential surface of the foot is pressed against an inner circumferential surface of the outer housing 4). The foot 51 may have a suitable shape and include suitable sealing components to reduce or prevent liquid from leaking between the outer surface of the foot 51 and the inner surface of the housing 4.

The air tube 52 extends up from the bottom of the wells 53 and defines an internal air passage 58. When the upper clamping unit 5 is engaged with the outer housing 4, the air tube 52 extends up to and encircles the mouthpiece orifice 41. The outer housing 4 and/or the air tube 52 may be suitably configured so as to provide a liquid-(and optionally air-) tight seal between the two. As will be understood below, air/aerosol is intended to pass along the air tube 52 and out of the mouthpiece orifice 41, while the space around the air tube 52 and within the outer housing 4 defines the reservoir 46 for storing the liquid aerosol-generating material. Hence, it should be understood that, with the exception of the openings of the wells 53, the reservoir 46 is a sealed volume defined by the outer housing 4, the outer surface of the air tube 52, and the foot 51.

The lower support unit 7 is in the form of a block having a broadly flat top surface 71 and a flat bottom surface 72. A central air passage 73 extends upwardly from the bottom surface 72 to the top surface 71. On each side of the air passage 73, the block of the lower support unit 7 includes a through hole 74. In the example cartomizer 3 of FIG. 2, a co-moulded contact pad 75 in the form of a pin is inserted into the through holes 74. More specifically, each contact pad 75 is press fit in its respective through hole 74. Each contact pad 75 provides an electrical connection path from the bottom surface 72 to a respective end portion of the heater assembly 6 when the heater assembly 6 is sandwiched between the top surface 71 of the lower support unit 7 and the recess of the bottom surface 55 of the upper clamping unit 5.

Much like the upper clamping unit 5, the lower support unit 7 is designed to engage with the outer housing 4 (more specifically, such that the outer circumferential surface of the lower support unit 7 is pressed against an inner circumferential surface of the outer housing 4). The lower support unit 7 may have a suitable shape and include suitable sealing components to reduce or prevent liquid from leaking between the outer surface of the lower support unit 7 and the inner surface of the housing 4. The foot 51 of the upper clamping unit 5 and the lower support unit 7 (with its block-like form) combine together to form a plug which seals the bottom end of the reservoir.

As shown in FIG. 2, the cartomizer 3 includes an end cap 8 at its bottom end. The end cap 8 is made of metal and serves to assist with retaining the cartomizer 3 in the aerosol provision device 2 when the cartomizer 3 is plugged in to the top end of the aerosol provision device 2, because, in this example, the aerosol provision device 2 is provided with magnets which are attracted to the metal of the end cap 8. The end cap 8 has a bottom wall 81 with a central opening (not shown in FIG. 2). The end cap 8 also has a circumferential side wall 83 which has two opposed cut-outs 84 which latch onto corresponding projections 49 on the outer surface of the bottom end of the side wall 44 of the outer housing 4, so that the end cap 8 has a snap-fit type connection onto the bottom end of the outer housing 4. When the end cap 8 has been fitted in position, it holds in position the lower support unit 7, the upper clamping unit 5 and the heater assembly 6 which is sandwiched between the lower support unit 7 and the upper clamping unit 5.

It would be possible to omit the end cap 8 (in order to reduce the component count) by arranging for the lower support unit 7 to form a snap-fit type connection with the bottom end of the side wall 44 of the outer housing 4. Additionally, the cartomizer 3 could be provided with indentations which engage with projections at the top end 21 of the main housing 2, so that a releasable connection is provided between the cartomizer and the main housing.

In any case, the cartomizer 3 is provided what may more generally be referred to as a device interface which is a part of the cartomizer 3 that interfaces with the main housing 2 (or aerosol-generating device). In the above example, the device interface may include the metal cap 8 including the bottom wall 81 and circumferential side wall 83 and/or the lower support unit 7 including the bottom surface 72. More generally, the device interface of the cartomizer 3 may encompass any part or parts of the cartomizer 3 that contact, abut, engage or otherwise couple to the main housing 2.

When the components of the cartomizer 3 have been assembled together, an overall air passage exists from the bottom end 32 to the top end 31 of the cartomizer 3 and it is formed by the air passage 73 leading to the air passage 58 which, in turn, leads to the mouthpiece orifice 41. With reference back to FIG. 1, the top end 21 of the aerosol provision device 2 includes an air inlet hole 22 on each side of the aerosol provision device 2 (with one of the two air inlet holes 22 being visible in FIG. 1). Air can enter the air inlet holes 22 and flow transversely inwards to the longitudinal axis L1 so as to enter the bottom end of the air passage 73 of the lower support unit 7 and to start to flow in the direction of the longitudinal axis L1 towards the mouthpiece 33.

As will be seen in FIG. 2, the heater assembly 6 includes an opening, herein referred to as an airflow channel 65. When the heater assembly 6 is positioned between the lower support unit 7 and the upper clamping unit 5, the airflow channel 65 through the heater assembly 6 is provided in fluid communication with the air passage 73 and the air passage 58. That is to say, the airflow channel 65 completes an air passage between the respective airflow passages 58, 73 of the upper clamping unit 5 and the lower support unit 7 respectively, thereby providing an air passage through these components to the mouthpiece orifice 41. That is, the cartomizer 3 comprises a cartomizer airflow channel which extends generally from an air inlet of the cartomizer 3 (e.g., the start of air passage 73) to an air outlet of the cartomizer (e.g., the mouthpiece orifice 41). The heater assembly 6 is located at a position within the cartomizer airflow channel between this air inlet and air outlet. More particularly, the airflow channel 65 is provided in the heater assembly 6 which fluidly communicates with the air inlet and the air outlet to complete the cartomizer airflow channel.

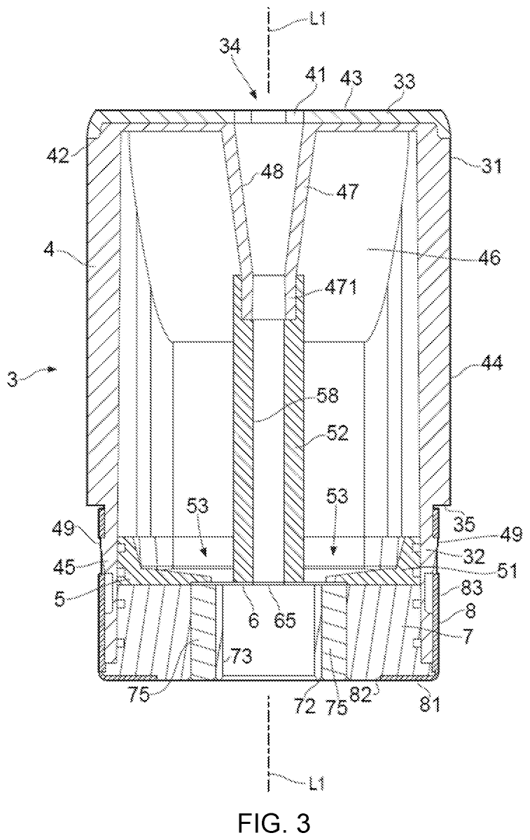

FIG. 3 is a cross-sectional view through the cartomizer 3 of FIGS. 1 and 2 when the cartomizer 3 is in its assembled state.

As seen in FIG. 3, the air passage 73 is provided through the lower support unit 7, extending from the lower, bottom surface 72 of the lower support unit 7 to an opposite, top surface 71. In this example, the air passage 73 is relatively wider than the air passage 58 formed in the upper clamping unit 5. As shown in FIG. 3, this provides a region where the bottom of the wells 53 overlap a part of the heater assembly 6 that is directly above the air passage 73. The significance of this is explained in more detail below. However, it should be appreciated that this is optional, and in other implementations the part of the heater assembly 6 that overlaps the wells 53 is not provided above the air passage 73.

As shown in cross-section in FIG. 3, the heater assembly 6 has an airflow channel 65 which has a broadly similar, or the same, cross-section when viewed along the longitudinal axis L1 as the cross-section of the air passage 58. That is, the inside edges of the airflow channel 65 of the heater assembly substantially line up with the inside edges of the air tube 52, such that air may flow freely through the air passage 58. In the described example, the air passage 58 and airflow channel 65 have a substantially circular cross-section when viewed along the longitudinal axis L1, and accordingly the diameter of the cross-section of the air passage 58 and the diameter of the cross-section of the airflow channel 65 are the same or substantially the same.

However, in other implementations, the cross-section of the heater assembly 6 may be different both in terms of shape and dimensions. In respect of the example above, and, in particular, the diameter of the airflow channel 65 may be smaller than the diameter of the air passage 58. In such implementations, the heater assembly 6 may protrude, at least partly, into the air passage 58. In either case, it should be appreciated that at least some of a surface of the heater assembly (and in particular the surface where aerosol generation occurs) is exposed to the air passage 73.

For completeness, FIG. 3 also shows the engagement of the air tube 52 with the outer housing 4. More specifically, the outer housing 4 comprises an air tube 47 which surrounds the mouthpiece orifice 41. The air tube 47 is shown having a conical-shape (or at least a tube with tapered sides). From FIG. 3, it may be seen that the top of the air tube 52 fits onto the bottom end 471 of the air tube 47 which extends downwards from the mouthpiece orifice 41 in the top face 43 of the outer housing 4. Thus, the air passage 58 is connected to an air passage 48 of the air tube 47. Also shown in FIG. 3 is the reservoir 46 formed between the air tube 52, the inside of the circumferential side wall 44 of the outer housing 4 and the upper clamping unit 5, as described above.

Turning now to the heater assembly 6, the heater assembly 6 is a microfluidic heater assembly.

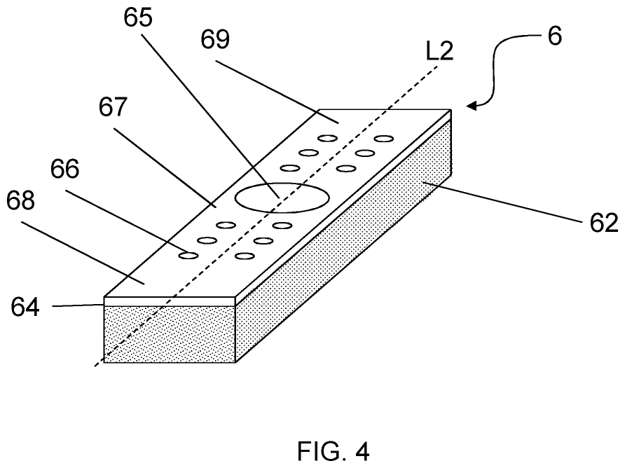

FIG. 4 illustrates the microfluidic heater assembly 6 in more detail. The microfluidic heater assembly of FIG. 4 is not shown to scale and certain features are exaggerated for reasons of clarity.

The microfluidic heater assembly 6 comprises a substrate 62 and an electrically resistive layer 64 disposed on a surface of the substrate 62.

In this implementation, the substrate 62 is formed from a non-conductive material, such as quartz (silicon dioxide); however, it should be appreciated that other suitable non-conductive materials may be used, such as ceramics, for example. The substrate 62 may be formed from a bulk material (such as cultured quartz) or as a sintered material, e.g., from sintered powdered quartz. The electrically resistive layer 64 is formed from any suitable electrically conductive material, for example a metal or a metal alloy such as titanium or nickel chromium.

The heater assembly 6 is planar and in the form of a cuboidal block, elongate in the direction of a longitudinal axis L2. The heater assembly 6 has the shape of a strip and has parallel sides. The planar heater assembly 6 has parallel upper and lower major (planar) surfaces and parallel side surfaces and parallel end surfaces. In the shown implementation of FIG. 4, the length of the heater assembly 6 is 10 mm, its width is 3 mm, and its thickness is 0.12 mm. The small size of the heater assembly 6 enables the overall size of the cartomizer to be reduced and the overall mass of the components of the cartomizer to be reduced. However, it should be appreciated that in other implementations, the heater assembly 6 may have different dimensions and/or shapes depending upon the application at hand.

Along the longitudinal axis L2, the heater assembly 6 has a central portion 67 and first and second end portions 68, 69. In FIG. 4, the length of the central portion 67 (relative to the lengths of the end portions 68, 69) has been exaggerated for reasons of visual clarity. When the vaporizer is in situ in the cartomizer, the central portion 67 is positioned overlapping the air passage 73 and air passage 58. More particularly, the central portion 67 extends across the top end of the air passage 73 of the lower support unit 7 and across the bottom end of the air passage 58 of the upper clamping unit 5. The end portions 68, 69 are clamped between the upper clamping unit 5 and the lower support unit 7.

The central portion 67 comprises the airflow channel 65, which is shown as a cylindrical tube extending through the heater assembly 6 (that is, from one side of the heater assembly 6 to the opposite side of the heater assembly 6). More specifically, the airflow channel 65 extends from the side of the heater assembly 6 opposite the electrically resistive layer 64 (the largest surface of the heater assembly 6 not shown in FIG. 4), through the substrate 62 toward the face of the substrate 62 on which the electrically resistive layer 64 is disposed, and then through the electrically resistive layer 64 itself. The airflow channel 65 follows a substantially linear path; that is, the airflow channel extends linearly, or substantially linearly, from the exposed surface of the substrate 62. As described above, the airflow channel 65 overlaps the air passage 73 and the air passage 58 such that air may flow through the airflow channel 65 from the air passage 73 to the air passage 58.

It should be understood that the airflow channel 65 may take any suitable shape, such as a square/cuboid-shaped tube, and the specific shape of the airflow channel 65 may depend on the specific implementation of the cartomizer 3 at hand.

In the central portion 67 of the heater assembly 6, a plurality of capillary tubes 66 are also provided. Only the openings of the capillary tubes 66 are shown in FIG. 4 (and in an exaggerated way for clarity), but the capillary tubes 66 extend from one side of the heater assembly 6 to the other. More specifically, the capillary tubes 66 extend from the side of the heater assembly 6 opposite the electrically resistive layer 64 (the largest surface of the heater assembly 6 not shown in FIG. 4), through the substrate 62 toward the face of the substrate 62 on which the electrically resistive layer 64 is disposed, and then through the electrically resistive layer 64. The plurality of capillary tubes 66 extend substantially linearly through the heater assembly 6 (that is, the capillary tubes 66 follow substantially linear paths). By substantially, it is meant that the capillary tubes 66 follow pathways that are within 5%, within 2% or within 1% of a straight line. This measure may be obtained in any suitable way, e.g., by comparison of the length of the distance from a first point to a second point along the extent of the capillary tube 66 and the corresponding distance that the central axis of the capillary tube 66 extends between the same two points. The capillary tubes 66 are formed in the heater assembly 66 via a manufacturing process. That is to say, the capillary tubes 66 do not naturally exist in the substrate material 62 or electrically resistive layer 64, but rather, the capillary tubes 66 are formed in the substrate material 62 and electrically resistive layer 64 through a suitable process. A suitable process for forming the capillary tubes 66, particularly when forming capillary tubes that substantially follow a linear path, is laser drilling. However, any other suitable technique may be employed in order to generate the capillary tubes 66.

The capillary tubes 66 are configured so as to transport liquid from one surface of the heater assembly 6 (i.e., the surface opposite the electrically resistive layer 64) to the electrically resistive layer 64. The exact dimensions of the capillary tubes 66, and in particular the diameter, may be set in accordance with the liquid to be stored in the reservoir 46 of the cartomizer 3 and subsequently used with the heater assembly 6. For example, the properties of the liquid aerosol-generating material (e.g., viscosity) in the reservoir 46 of the cartomizer 3 may dictate the diameter of the capillary tubes 66 to ensure that a suitable flow of liquid is provided to the electrically resistive layer 64. However, in some implementations, the capillary tubes 66 may have a diameter on the order to tens of microns, e.g., between 10 μm to 250 μm, between 10 μm to 150 μm, or between 10 μm to 100 μm. However, it should be appreciated that capillary tubes 66 in other implementations may be set differently based on the properties of the liquid to be vaporized and/or a desired supply of liquid to the electrically resistive layer 64. Moreover, it should be appreciated that to achieve a desired level of flow of aerosol-generating material to the electrically resistive layer 64, not only the diameter of the capillary tubes 66 but also the number/number per unit area of the capillary tubes 66 may also influence the supply of liquid to the electrically resistive layer 64.

With reference back to FIG. 2, the heater assembly 6 is shown positioned between the upper clamping unit 5 and the lower support unit 7. In particular, the heater assembly 6 is oriented such that the electrically resistive layer 64 faces towards the lower support unit 7, while the substrate 62 faces towards the upper clamping unit 5.

It should be understood from FIG. 2 that the end portions 68, 69 of the heater assembly 6 overlap the through holes 74 and the contact pads 75. More specifically, the electrically resistive layer 64 is provided in contact with the contact pads 75, and therefore the end portions 68, 69 act to form an electrical connection with the contact pads 75 (and thus any power source subsequently attached to the contact pads 75, such as from the aerosol provision device 2). For example, the aerosol provision device 2 may have two power supply pins (not shown) which make contact with the bottom ends of the contact pads 75. The top ends of the contact pads 75 are in electrical contact with the heater assembly 6, as above. In use, electrical power supplied by the power supply of the aerosol provision device 2 passes through the electrically resistive layer 64, by virtue of the electrical connection between the end portions 68, 69 and the contact pads 75, to cause heating of the electrically resistive layer 64. The amount of heating achieved (i.e., the temperature of the electrically resistive layer 64 that is able to be reached) may depend on the power supplied by the aerosol provision device 2 and the electrical resistance of the electrically resistive layer 64. Equally, the amount of heating required (i.e., the temperature necessary to vaporize the liquid supplied to the resistive layer 64) will be dependent in part on the properties of the liquid supplied to the electrically resistive layer 64 and/or the configuration of heater assembly 6. Accordingly, the resistance of the electrically resistive layer 64 may be set based on the particular application at hand, whereby the resistance of the electrically resistive layer 64 may be dependent on the material of the electrically resistive layer 64 and the physical dimensions of the electrically resistive layer 64 (e.g., thickness). By way of example, the thickness of the electrically resistive layer 64 may be on the order of 5 μm or so, but it will be appreciated that this may vary from implementation to implementation.

In other implementations, the contact pads 75 may be omitted and the power supply pins (not shown) of the aerosol provision device 2 may alternatively pass through the through holes 74 of the lower support unit 7 to make direct electrical contact with the electrically resistive layer 64.

The configuration of the cartomizer 3 shown in FIGS. 2 and 3 is one where the vaporization of liquid occurs in a certain region of the heater assembly 6; namely, the central portion 67 of the heater assembly 6. The end portions 68, 69 of the heater assembly 6 are not especially suited for vaporizing liquid, firstly because these end portions 68, 69 are not provided with capillary tubes 66 extending through to the electrically resistive layer 64 in these portions, and secondly because the contact pads 75 contact a part of the surface of the electrically resistive layer 64 at the end portions 68, 69. As described above, the central portion 67 of the heater assembly 6 (or rather a part thereof) is positioned below the wells 53 of the upper clamping unit 5, but such that it overlaps the air passage 73 of the lower support unit 7. In this way, it should be understood that liquid from the wells 53/reservoir 46 is permitted to flow along the respective capillary tubes 66 overlapping the wells 53 to the electrically resistive layer 64 where the liquid is able to be subsequently vaporized when the electrically resistive layer 64 is energized. With reference to FIG. 3, it can be seen that in the regions where the heater assembly 6 overlaps the wells 53, liquid is supplied to the capillary tubes 66 in these areas and subsequently to the electrically resistive layer 64 where it is vaporized. The vapor is released from the heater assembly 6 below the electrically resistive layer 64 and into the portion of the air passage 73 below the heater assembly 6. Subsequently, air that is drawn through the air passage 73 passes by the heater assembly 6 and vaporized liquid aerosol generating material is able to be entrained in the drawn air before passing through the airflow channel 65 and to the air passage 58.

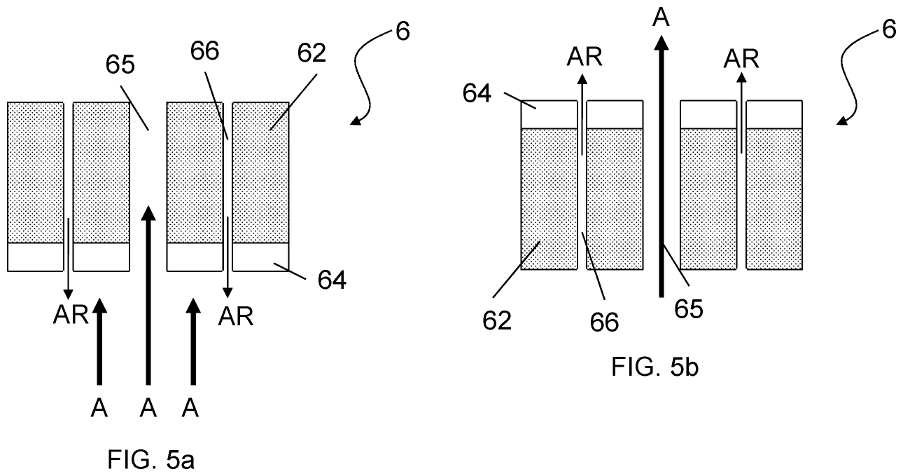

FIG. 5a schematically shows a cross-sectional view of a heater assembly 6. FIG. 5a shows a simplified version of the heater assembly 6 depicting two capillary tubes 66 and the airflow channel 65, alongside a representation of the various airflows, for the purposes of explaining the principles of the present disclosure. However, it should be understood that the principles described in FIG. 5a may be applied to suitable configurations of the heater assembly/cartomizer 3 comprising the heater assembly 6.

FIG. 5a is a representation of the arrangement of the heater assembly 6 in the cartomizer 3 of FIGS. 1 to 3. In particular, the heater assembly 6 is arranged such that the exposed larger surface of the substrate 62 faces upward (in the orientation of FIG. 5a) and the exposed larger surface of the electrically resistive layer 64 faces downward (in the orientation of FIG. 5a). This broadly mirrors the arrangement shown in FIG. 3 when the cartomizer 3 is held in a normal orientation. In this arrangement, as discussed above, the substrate 62 is in fluid communication with the reservoir 46 by virtue of the wells 53, while the electrically resistive layer 64 (or at least a part thereof) faces the air passage 73.

During use, liquid is transported along the capillary tubes 66 from the reservoir 46 to the electrically resistive layer 64 where, assuming the electrically resistive layer 64 is supplied with a suitable electrical current to cause heating, the liquid is vaporized/aerosolized. FIG. 5a represents the escape of aerosol from the heater assembly 6 through the arrows labelled AR.

Conversely, the air drawn into the aerosol provision system/cartomizer 3 is represented by the arrows labelled A. As discussed, in the cartomizer 3 of FIGS. 1 to 3, the air A enters the cartomizer 3 through the air passage 73 by virtue of the user inhaling at the mouthpiece end of the cartomizer 3. As the air A enters and passes through the air passage 73, some of the air A impinges on the surface of the electrically resistive layer 64 (shown by the shorter arrows in FIG. 5a). The direction of this air A is substantially opposite to the direction along which aerosol AR is emitted. Accordingly, as the air A enters the air passage 73, some of the air impinges on the surface of the electrically resistive layer 64 and/or collides with the released aerosol AR from the heater assembly 6. This causes more a more turbulent airflow in the vicinity of the electrically resistive layer 64 of the heater assembly 6. Some of the initial air entering the air passage 73 and some of the turbulent air (i.e., the air after it has impinged/collided as above) exits the air passage 73 through the airflow channel 65 of the heater assembly 6, as shown by the larger arrow labelled A. Subsequently, the air (including entrained aerosol) passes through the channel 65 and along air passage 58 to the mouthpiece orifice 41.

Without wishing to be bound by theory, providing a turbulent air flow in the vicinity of the electrically resistive layer 64 (which is correspondingly the area where aerosol is generated, i.e., the aerosol generation area or region) can lead to certain properties or characteristics of the aerosol being generated. For example, the turbulent airflow is considered to provide a greater probability for aerosol droplets to collide and coalesce, thereby providing droplets (or particles) of aerosol having a greater average diameter. Additionally, providing a turbulent airflow may also provide a generally longer average pathway for a given aerosol droplet to exit the aerosol provision system. This generally allows for a greater time period for the aerosol to cool. Both of these factors contribute to providing a different sensorial experience to the user. Hence, by providing a heater assembly 6 with an airflow channel 65 through the heater assembly 6 and by suitably arranging the heater assembly in the airflow path of the aerosol provision system 1, certain characteristics of the generated aerosol impacting the user's sensorial experience can be realised.

FIG. 5b schematically shows the same cross-sectional view of the heater assembly 6 of FIG. 5a; however, the heater assembly 6 is provided in a different configuration relative to the airflow as compared to FIG. 5a. As with FIG. 5a, FIG. 5b shows a simplified version of the heater assembly 6 depicting two capillary tubes 66 and the airflow channel 65, alongside a representation of the various airflows, for the purposes of explaining the principles of the present disclosure. However, it should be understood that the principles described in FIG. 5b may be applied to suitable configurations of the heater assembly/cartomizer 3 comprising the heater assembly 6.

In FIG. 5b, the heater assembly 6 is arranged substantially in the opposite configuration to FIG. 5a. That is, in FIG. 5a, the air flow A is broadly arranged such that the air flow A passes in the direction from the electrically resistive layer 64 to the opposite surface of the substrate 62, whereas in FIG. 5b, the air flow A is broadly arranged such that the air flow A passes in the direction from the opposite surface of the substrate 62 to the electrically resistive layer 64. That is, the heater assembly 6 is arranged such that the exposed larger surface of the substrate 62 faces downward (in the orientation of FIG. 5b) and the exposed larger surface of the electrically resistive layer 64 faces upward (in the orientation of FIG. 5b).

In such a configuration, the cartomizer 3 shown in FIGS. 1 to 3 may require some adaptations to permit this arrangement of the heater assembly 6. For example, with the heater assembly 6 in the arrangement of FIG. 5b, the electrically resistive layer 64 faces in the direction of the reservoir 46 (if one envisages rotating the heater assembly 6 of FIG. 2 or 3 by 180° about the longitudinal axis L2). In such an implementation, the heater assembly 6 may be spaced from the reservoir 46 and an aerosol-generating material transport element, such as a ceramic or cotton wick, may be provided to transport the liquid from the wells 53 to the exposed surface of the substrate 62 (for example, the wick may have a generally U-or C-shaped configuration to allow such transport of liquid). It should be appreciated that the cartomizer 3 may be adapted in other ways to accommodate such a configuration of the heater assembly 6.

During use, liquid is transported along the capillary tubes 66 from the reservoir 46 (via the wick) to the electrically resistive layer 64 where, assuming the electrically resistive layer 64 is supplied with a suitable electrical current to cause heating, the liquid is vaporized/aerosolized. FIG. 5b represents the escape of aerosol from the heater assembly 6 through the arrows labelled AR. Note that the direction of escape of aerosol AR is in the opposite direction to that of FIG. 5a.

The airflow the air drawn into the aerosol provision system/adapted cartomizer is represented by the arrows labelled A. In a broadly similar manner, air A enters the cartomizer through an air passage (similar to, but suitably adapted from, the air passage 73) by virtue of the user inhaling at the mouthpiece end of the cartomizer. In this example, the air passage corresponding to air passage 73 may be broadly the same size and shape as the airflow channel 65 of the heater assembly 6. As the air A enters and passes through the air passage corresponding to air passage 73, the air A passes straight through the airflow channel 65, as shown by the larger arrow labelled A in FIG. 5b. Even if the air passage corresponding to air passage 73 is sized differently (and in particular to be larger than) the airflow channel 65, by virtue of passing through the airflow channel 65 in the heater assembly 6, the air follows a broadly straight pathway. Correspondingly, when the air A leaves the heater assembly 6, the air A follows a substantially straight pathway. Conversely to FIG. 5a, in FIG. 5b the aerosol AR is entrained in the air A after the air A exits the heater assembly 6. Subsequently, the air (including entrained aerosol) passes along an air passage corresponding to the air passage 58 and along to the mouthpiece orifice 41.

Again, without wishing to be bound by theory, the air A after it exits the heater assembly 6 follows a substantially straight or linear path, and is therefore said to be a laminar flow of air. As the aerosol AR enters the laminar flow, in the opposite way to the turbulent configuration of FIG. 5a, the laminar airflow is considered to provide a relatively smaller probability for aerosol droplets to collide and coalesce, thereby providing droplets (or particles) of aerosol having a relatively smaller average diameter. Additionally, providing a laminar airflow may also provide a relatively shorter average pathway for a given aerosol droplet to exit the aerosol provision system, which relatively shortens the time period for the aerosol to cool. Both of these factors contribute to providing a different sensorial experience to the user. Accordingly, providing a laminar airflow in the vicinity of the electrically resistive layer 64 (which is correspondingly the area where aerosol is generated, i.e., the aerosol generation area or region) can lead to certain properties or characteristics of the aerosol being generated. Hence, as above, by providing a heater assembly 6 with an airflow channel 65 through the heater assembly 6 and by suitably arranging the heater assembly in the airflow path of the aerosol provision system 1, certain characteristics of the generated aerosol impacting the user's sensorial experience can be realised.

It should be understood that by providing a heater assembly 6 with an airflow channel 65 running from one side of the heater assembly 6 (i.e., one side with the largest exposed surface) to an opposite side of the heater assembly 6, such as that described in FIG. 4, allows for some degree of flexibility in the arrangement of the heater assembly 6 particularly with respect to the airflow direction through the heater assembly 6. As discussed above, the way in which the heater assembly 6 is arranged can impact on the relative properties or characteristics of the aerosol that is generated and subsequently impacts the user sensory experience when using an aerosol provision system 1 employing a specific configuration of the heater assembly 6. It should be understood that other factors may impact the sensorial experience (e.g., the length of the air tube 52, power provided to the heater assembly 6, etc.) but for comparable systems, orientating the heater assembly 6 in one orientation over another can impact the properties/characteristics of the aerosol generated. This provides a somewhat greater degree of flexibility for the designer of an aerosol provision system 1. For example, this may mean that the characteristics of the generated aerosol can be modified as described above and/or the configuration of the cartomizer can be modified while retaining the same or similar aerosol characteristics (for example, to meet certain size requirements of the cartomizer).

In each of the above examples of FIGS. 5a and 5b, the cross-sectional area of the airflow channel 65 when viewed along the direction of extent of the airflow channel 65 (that is, from one side of the heater assembly 6 (i.e., one side with the largest exposed surface) to an opposite side of the heater assembly 6) is greater than the cross-sectional area of one capillary tube 66 when viewed along the direction of extent of the capillary tube 66. It is understood that, for capillary tubes 66 having a circular cross-section, the capillary tubes 66 have a diameter which may be on the order of 10 to 100 μm, whereas the diameter/extent of the airflow channel 65 may be considerably greater than this, e.g., on the order of 1 to 2 mm. The airflow channel 65 has a considerably larger cross-sectional area than a single capillary tube 66 to allow for a sufficient passage of air through the heater assembly 6 to the mouthpiece orifice 41. However, it should be appreciated that the total cross-sectional area of all capillary tubes 66 may be greater than (or less than) the cross-sectional area of the airflow channel 65 depending on the implementation at hand.

In the described examples, the airflow channel 65 is provided along the center of the heater assembly 6. That is, the airflow channel 65 is provided having a longitudinal axis of extent from one side of the heater assembly to another, opposite side of the heater assembly which broadly aligns with the central axis of the heater assembly extending through the corresponding sides of the heater assembly. Providing the airflow channel 65 in the center of the heater assembly 6 may permit greater flexibility in terms of orientating the heater assembly 6 (e.g., as in FIGS. 5a and 5b) with fewer changes required to the cartomizer design to accommodate either configuration. However, in other implementations, the heater assembly 6 may be provided with an airflow channel 65 that is provided off center.

In the described examples, only a single airflow channel 65 is shown in the heater assembly 6. However, in other implementations, the heater assembly 6 may be provided with a plurality of airflow channels 65 extending through the heater assembly from one side of the heater assembly 6 to another opposite side of the heater assembly 6. The airflow channels 65 may all follow substantially the same pathway/extend in the same direction. Such a configuration may be employed to help increase the total amount of air that is able to pass through the heater assembly 6. The plurality of airflow channels 65 may all be the same (e.g., have the same size, same cross-sectional shape, etc.) or may be different.

In the described examples, the airflow channel 65 extends along a direction normal to the electrically resistive layer 64 (or the plane which accommodates the electrically resistive layer 64) on the first surface of the substrate 62. In respect of the arrangement of FIG. 5a, this allows for the production of relatively more turbulent airflow, as compared to providing the heater assembly 6 and/or airflow channel 65 at an angle to the normal. Conversely, in the arrangement of FIG. 5b, the airflow channel 65 is substantially parallel to the direction along which aerosol is emitted/expelled from the heater assembly 6 and therefore interferes with the flow of aerosol from the heater assembly to a lesser degree.

However, it should be understood that other implementations may utilize the heater assembly 6 with cartomizers 3/systems 1 having different airflow paths. For example, with reference to FIGS. 5a and 5b, in some implementations, the airflow may initially travel horizontally (i.e., along the surface of the heater assembly 6) before proceeding along the air channel 65. In the configuration of FIG. 5a, turbulent air at least in the vicinity of the aerosol emitted by the capillary tubes 66 can still occur, not least through the airflow intercepting the emitted aerosol as it leaves the heater assembly 6. However, the degree of turbulent air flow may be slightly less than for the airflow arrangement of FIG. 5a. In the configuration of FIG. 5b, laminar air flow at least in the vicinity of the aerosol emitted by the capillary tubes 66 can still occur, not least because the airflow passes through the airflow channel 65 which may block or hinder some of the turbulent air. However, the degree of laminar air flow may be slightly less than for the airflow arrangement of FIG. 5b (or in other words, there may be slightly more turbulent air in such a modification). However, more broadly it should be appreciated that the airflow to the heater assembly 6 may be configured in any desired way provided the airflow is subsequently able to flow through the air channel 65 of the heater assembly 6.

Additionally, it should be understood that the airflow channel 65 extends broadly following a linear pathway, from one side to an opposite side of the heater assembly.

Furthermore, the above disclosure has focused on examples of the heater assembly 6 whereby liquid is fed generally in a vertical direction from the wells 53 of the cartomizer to the capillary tubes 66 (and subsequently to the electrically resistive layer 64). However, in some implementations, the heater assembly 6 may be provided with a transport element, such as a porous material, which permits horizontal transport of liquid across the length of the heater assembly (e.g., in the direction parallel to the longitudinal axis L2). For the example, the transport element may be a separate porous element, such as a fibrous pad or the like which is positioned between the heater assembly 6 and the wells 53 of the cartomizer 3. Alternatively, the substrate 62 of the heater assembly 6 may be formed of a sintered material (such as sintered quartz) or other fibrous material which is suitably configured to allow for horizontal movement of the liquid. In such examples, the wells 53 may be positioned above regions of the heater assembly which do not comprise capillary tubes 66 (e.g., the end regions 68, 69) and liquid is permitted to flow horizontally towards the regions that do comprise capillary tubes 66 (e.g., the central region 67) before passing along the capillary tubes 66 to the electrically resistive layer 64.

The heater assembly 6 as described above is generally provided as a relatively small component having a relatively small footprint (as compared to more traditional heater assemblies, such as a wick and coil). However, owing in part to the fact the capillary tubes 66 are formed via a manufacturing process in the heater assembly 6 (i.e., the capillary tubes are engineered through a laser drilling process), the heater assembly 6 can provide similar liquid delivery characteristics (and thus comparable aerosol formation characteristics) despite its relatively small size. That is to say, the heater assembly 6 may provide more efficient wicking of liquid given that that diameter of the capillary tubes 66 can be selected/optimised for a given liquid to be vaporized and that the capillary tubes 66 are formed to follow substantially linear paths that directly deliver the liquid to the electrically resistive layer 64. By providing a smaller component, material wastage (e.g., when the cartomizer 3 is disposed of) can be reduced.

Not only can the liquid be provided more efficiently to the electrically resistive layer 64, but by manufacturing the capillary tubes 66, more control is given over the supply of liquid to the electrically resistive layer 64 (that is, the more capillary tubes of a certain diameter, the more liquid per unit time (ml/s) can be delivered to the electrically resistive layer 64).

It should be appreciated that the configuration of the cartomizer 3 accommodating the heater assembly 6 is provided as an example configuration of such a cartomizer 3. The principles of the present disclosure apply equally to other configurations of the cartomizer 3 (for example, comprising similar or different components to those as shown in FIGS. 1 to 3, and a similar or different layout to that shown in FIG. 2). That is, the cartomizer 3 and the relative position of the heater assembly 6 in the cartomizer 3 is not significant to the principles of the present disclosure. Broadly speaking, a cartomizer is likely to comprise a top end (having the mouthpiece orifice 41) and a bottom end. In the examples shown above, the heater assembly 6 is arranged to be below the reservoir 46, substantially horizontal to the longitudinal axis of the cartomizer 3, and arranged in an airflow path that is substantially perpendicular to longitudinal axis of the heater assembly. However, this need not be case, and in other implementations the cartomizer 3 may be configured differently depending on the particular design and application at hand, as described above.

In the example shown in FIG. 2, the contact pads 75 directly contact the electrically resistive layer 64 of the heater assembly 6. However, the cartomizer 3 may be provided with any suitable arrangement that facilitates the electrical contact between the aerosol provision device 2 and the heater assembly 6. For example, in some implementations, electrical wiring or other electrically conductive elements may extend between the electrically resistive layer 64 and the contact pads 75 of the cartomizer 3. This may particularly be the case when the heater assembly 6 has its largest dimension (e.g., its length) less than a minimum distance between the contact pads 75. The distance between the contact pads 75 may be dictated by the electrical contacts on the aerosol provision device 2.

It should also be appreciated that while the above has described a cartomizer 3 which includes the heater assembly 6, in some implementations the heater assembly 6, may be provided in the aerosol provision device 2 itself. For example, the aerosol provision device 2 may comprise the heater assembly 6 and a removable cartridge (containing a reservoir of liquid aerosol-generating material). The heater assembly 6 is provided in fluid contact with the liquid in the cartridge (e.g., via a suitable wicking element or via another fluid transport mechanism). Alternatively, the aerosol provision device 2 may include an integrated liquid storage area in addition to the heater assembly 6, which may be refillable with liquid. More broadly, the aerosol provision system (which encompasses a separable aerosol provision device and cartomizer/cartridge or an integrated aerosol provision device and cartridge) includes the heater assembly.

Additionally, the above has described a heater assembly 6 in which an electrically resistive layer 64 is provided on a surface of the respective substrate. In the aerosol provision system 1 of FIG. 2, electrical power is supplied to the electrically resistive layer 64 via the contact pads 75. Accordingly, an electrical current is able to flow through the electrically resistive layer 64 from one end to the other to cause heating of the electrically resistive layer 64. However, it should be understood that electrical power for the purposes of causing the electrically resistive layer 64 to heat may be provided via an alternative means, and in particular, via induction. In such implementations, the aerosol provision system 1 is provided with a coil (known as a drive coil) to which an alternating electrical current is applied. This subsequently generates an alternating magnetic field. When the electrically resistive layer 64 is exposed to the alternating magnetic field (and it is of sufficient strength), the alternating magnetic field causes electrical current (Eddy currents) to be generated in the electrically resistive layer 64. These currents can cause Joule heating of the electrically resistive layer 64 owing to the electrical resistance of this layer 64. Depending on the material which the electrically resistive layer 64 is formed, heating may additionally be generated through magnetic hysteresis (if the material is ferro-or ferrimagnetic). More generally, the electrically resistive layer 64 is an example of a heater layer of the heater assembly 6 which is configured to generate heat when supplied with energy (e.g., electrical energy), which, for example, may be provided through direct contact or via induction. Additional ways of causing the heater layer to generate heat are also considered within the principles of the present disclosure.

Moreover, it should be understood that in some implementations, an additional layer or layers, e.g., serving as a protective layer, may be disposed on top of the electrically resistive layer 64. In such implementations, the capillary tubes 66 still extend to an opening on the electrically resistive layer 64 but may additionally extend through the additional layer(s). More broadly, the capillary tubes 66 extend through the heater assembly 6 to an opening at a surface of a side of the heater assembly 6 comprising the electrically resistive layer 64, which includes an opening in the electrically resistive layer 64 itself as well as an opening in any additional layer(s) positioned above the electrically resistive layer 64.

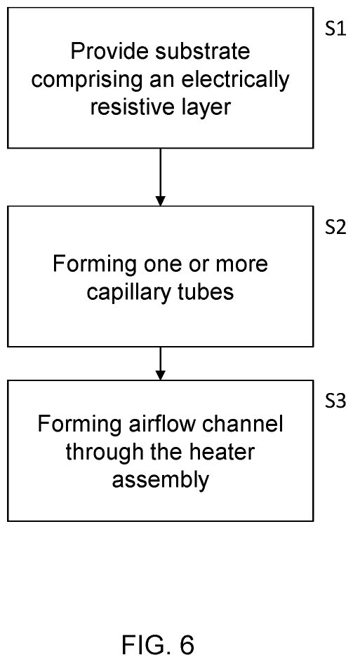

FIG. 6 depicts an example method for manufacturing the heater assembly 6.

The method begins at step S1 by providing a substrate 62 comprising an electrically resistive layer 64 provided on a first surface of the substrate. The way in which the substrate 62 is formed is not significant to the principles of the present disclosure. For example, the substrate 62 may be cut from a portion of cultured quartz or formed via a sintering process by sintering quartz powders/fibers, for example. The way in which the electrically resistive layer 64 is formed on the surface of the substrate 62 is not significant to the principles of the present disclosure. For example, the electrically resistive layer 64 may be a sheet of metal (e.g., titanium) adhered, welded, or the like to the substrate 62. Alternatively, the electrically resistive layer 64 may be formed through a vapor or chemical deposition technique using the substrate 62 as a base. Yet a further alternative is to grow or culture the substrate 62 using the electrically resistive layer 64 as a base.

Once the substrate 62 including an electrically resistive layer 64 is provided, the method proceeds to step S2 where one or more capillary tubes 66 are formed in the substrate 62/electrically resistive layer 64. As noted above, the capillary tubes 66 extend from a surface (another surface) of the substrate 62 through the electrically resistive layer 64 provided on the first surface of the substrate 62. That is, as shown in FIGS. 4a to 5b, the capillary tubes 66 extend all the way through the heater assembly 6. The capillary tubes 66 may be formed by laser drilling, as noted above, or any other suitable technique.

After or during step S2, the method proceeds to step S3. At step S3, an airflow channel 65 extending from a surface of the substrate 62 through the electrically resistive layer 64 provided on the opposite surface of the substrate 62 is formed. The airflow channel 65 is configured to allow air to flow through the heater assembly 6 as described above. The airflow channel 65 may be formed using any suitable manufacturing technique (including laser drilling and/or conventional drilling).

Thereafter, once the heater assembly 6 is formed, the heater assembly 6 may be positioned in a cartomizer 3 or more generally an aerosol provision system 1.

It should be appreciated that although steps SI to S3 are shown in a certain order in FIG. 6, in some implementations the method steps may be performed in an alternative sequence. For example, in some implementations, capillary tubes 66 may be formed in the substrate 62 prior to providing the electrically resistive layer 64 (e.g., via a deposition technique). In such implementations, step S2 and optionally step S3 may precede step S1, noting that the provision of a substrate 62 is required for step S2 and optionally step S3 to be performed. Additionally, step S3 may be performed prior to step S2; that is, the air channel 65 may be formed prior to the formation of the capillary tubes 66. Thus, it should be understood that the method of FIG. 6 is an example method only, and adaptations to the steps or ordering of the steps of this method are contemplated within this disclosure.

Thus, there has been described a heater assembly for an aerosol provision system, the heater assembly including: a substrate; a heater layer configured to generate heat when supplied with energy, the heater layer provided on a first surface of the substrate; one or more capillary tubes extending from another surface of the substrate through the heater layer provided on the first surface of the substrate; and an airflow channel extending from another surface of the substrate through the heater layer provided on the first surface of the substrate, the airflow channel configured to allow air to flow through the heater assembly. Also described is a cartomizer including the heater assembly, an aerosol provision system including the heater assembly, and a method for manufacturing the heater assembly.

While the above described embodiments have in some respects focussed on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A heater assembly for an aerosol provision system, the heater assembly comprising:
a substrate;
a heater layer configured to generate heat when supplied with energy, the heater layer provided on a first surface of the substrate;
one or more capillary tubes extending from another surface of the substrate through the heater layer provided on the first surface of the substrate; and
an airflow channel extending from another surface of the substrate through the heater layer provided on the first surface of the substrate, the airflow channel configured to allow air to flow through the heater assembly.

2. The heater assembly of claim 1, wherein the airflow channel extends from a surface of the substrate opposite the first surface.

3. The heater assembly of claim 1, wherein the airflow channel extends along a direction normal to the heater layer on the first surface of the substrate.

4. The heater assembly of claim 1, wherein the airflow channel extends linearly, or substantially linearly, from the another surface.

5. The heater assembly of claim 1, wherein the cross-sectional area of the airflow channel when viewed along the direction of extent of the airflow channel is greater than the cross-sectional area of one capillary tube when viewed along the direction of extent of the capillary tube.

6. The heater assembly of claim 1, wherein the airflow channel is provided along the center of the heater assembly.

7. A cartomizer for use with an aerosol-generating device for generating aerosol from an aerosol-generating material, the cartomizer comprising:
a reservoir for storing aerosol-generating material, and
heater assembly according to claim 1, wherein the heater assembly is provided in fluid communication with the reservoir.

8. The cartomizer of claim 7, wherein the cartomizer comprises a cartomizer airflow channel and wherein the heater assembly is arranged such that the airflow channel of the heater assembly fluidly communicates with the airflow channel of the cartomizer.

9. The cartomizer of claim 8, wherein the cartomizer airflow channel extends from an air inlet of the cartomizer to an air outlet of the cartomizer, and wherein the heater assembly is located at a position within the cartomizer airflow channel between the air inlet and the air outlet.

10. The cartomizer of claim 7, wherein regions of the heater assembly comprising the one or more capillary tubes are arranged to be in fluid communication with the reservoir.

11. An aerosol provision system for generating aerosol from an aerosol-generating material, the aerosol provision system comprising the heater assembly of claim 1.

12. An aerosol provision system comprising an aerosol provision device and a cartomizer for use with an aerosol provision device for generating aerosol from an aerosol-generating material, the cartomizer comprising:
a reservoir for storing aerosol-generating material, and
a heater assembly according to claim 1, wherein the heater assembly is provided in fluid communication with the reservoir,
wherein the cartomizer artomiser is releasably connectable to the aerosol provision device.

13. A method of manufacturing a heater assembly for an aerosol provision system, the method comprising:
providing a substrate comprising a heater layer configured to generate heat when supplied with energy, the heater layer provided on a first surface of the substrate;
forming one or more capillary tubes extending from another surface of the substrate through the heater layer provided on the first surface of the substrate; and
forming an airflow channel extending from another surface of the substrate through the heater layer provided on the first surface of the substrate, the airflow channel configured to allow air to flow through the heater assembly.

14. Heater means for an aerosol provision system, the heater means comprising:
a substrate;
heater layer means configured to generate heat when supplied with energy, the heater layer means provided on a first surface of the substrate;
capillary means extending from another surface of the substrate through the heater layer means provided on the first surface of the substrate;
and airflow means extending from another surface of the substrate through the heater layer means provided on the first surface of the substrate, the airflow means configured to allow air to flow through the heater means.
